(19) United States
(12) Patent Application Publication
(10) Pub. No.: US 2025/0171606 A1
(43) Pub. Date: May 29, 2025

(54) CHEMOENZYMATIC DEGRADATION OF EPOXY COMPOSITES

(71) Applicant: SYENSQO SA, Brussels (BE)

(72) Inventors: Victor Ferrão, Campinas São Paulo (BR); Stéphane Streiff, Lyon (FR); Priscila Maziero, Campinas, Sao Paulo (BR); Claude Billaud, Lyon (FR); Fan Jiang, Shanghai (CN); Tao Lin, Shanghai (CN)

(73) Assignee: SYENSQO SA, Brussels (BE)

(21) Appl. No.: 18/715,552

(22) PCT Filed: Dec. 1, 2021
(86) PCT No.: PCT/CN2021/134704

§ 371 Date: Jun. 3, 2024

(51) Int. Cl. C08J 11/10; C08J 11/08; C08J 11/16; D01F 9/12

(52) U.S. Cl. CPC C08J 11/105; C08J 11/08; C08J 11/16; D01F 9/12; C08J 2363/02; D10B 2505/02

(57) ABSTRACT

A method for degrading an epoxy composite material and recycling of carbon fibers comprises a step of submitting the epoxy composite material to a solvent treatment at a temperature that is at least 10° C. above the glass transition temperature, and a following step of enzymatic treatment.

### FIELD OF INVENTION

The invention refers to a method for degrading epoxy composites by chemoenzymatic route, in particular by chemically pretreating an epoxy composite in a solvent followed by enzymatic treatment comprising one or more enzymes and a chemical post-treating. The invention also deals with a method for recovering and recycling carbon fibers from an epoxy composite material.

### BACKGROUND OF THE INVENTION

Composite materials are structurally compact and hindered materials, causing difficulties in developing processes of recycling/degradation of its structures.

Composite materials comprising carbon-fibers and epoxy resins are widely used notably in aeronautics, aerospace and automotive industries.

The increasing global demand for lightweight materials using carbon fiber-reinforced polymers leads to an increase in the demand for carbon fibers.

The absence of effective recovering and recycling methods for composites aligned with the increasing demand for such a composites implies on growing amounts of waste at the end of these product's life.

Different kinds of degradations of epoxy resins comprised in composites structures have already been developed such as thermal degradation (pyrolytic decomposition of epoxy resin), chemical degradation (degradation of epoxy resin by acids or supercritical fluids) or mechanical degradation (shredding, crushing and grinding of the composite material). However, these techniques have several drawbacks. They tend to either lower the quality of the carbon fibers, or they are very energy consuming and imply handling toxic substances.

Ma, Y et al. (Polymer Degradation and Stability 2018, 153, 307-317) have evaluated traditional chemical degradation using depolymerization and acid digestion of epoxy resins after pre-treatment with solvent or mechanical shredding of epoxy composites. However, results are provided using aggressive chemical conditions and applied in thin composites and with a few number of carbon fiber sheets.

Enzymatic degradation implies generally mild and safe conditions which have less impact on the environment.

Enzymatic degradation of polymers has been essentially evaluated on lignin, polyesters, polyamides or polyurethanes (US 2016/0280881, US 2009/0162337, WO 99/29885, U.S. Pat. No. 6,255,451), but not on epoxy resins.

Eliaz et al. (Materials 2018, 11, 2123) have evaluated microbial degradation of epoxy resins. Two bacterial species were identified as being potentially able to degrade epoxy resins: Rhodococcus rhodochrous and Ochrobactrum anthropi.

Moeser et al. (Advanced Materials Research 2014, 1018, 131-136) report also evaluation of degradation of uncured epoxy resins by microorganisms. However, the results are not clear.

Despite advances in technologies for degradation of epoxy composites, there is a need to provide a method using mild conditions, able to effectively recover high quality carbon fibers from thin or thick composites, in order to address not only the environmental impact for waste derived from such products but also to guarantee the expansion of the marketing products without a negative impact to the environment.

### SUMMARY OF THE INVENTION

Pursuing its research in this field, the Applicant has now found an original method able to degrade thin and thick epoxy composites and comprising lots of carbon fiber sheets by chemoenzymatic method using mild conditions leading to recovery and recycling of high quality carbon fibers.

A first object of the present invention refers to a method for degrading a composite material comprising the following successive steps:
a) submitting a composite material CM comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1,
wherein the treatment temperature Tₜᵣ exceeds by at least 10° C. the glass transition temperature Tg of the composite material CM as determined by DSC in accordance ASTM E1356-08(2014),
with the proviso that
when no glass transition temperature can be detected by DSC in accordance ASTM E1356-08(2014), the treatment temperature Tₜᵣ satisfies at least one condition chosen from conditions (c1) and (c2),
wherein condition (c1) is that a glass transition temperature T_{g2} can be determined by DMA in accordance with ASTM D7028-07(2015) and the treatment temperature Tₜᵣ exceeds by at least 10° C. the glass transition temperature T_{g2}, and
wherein condition (c2) is that the treatment temperature is of at least 300° C., then,
b) submitting the composite material obtained after the step a) to an enzymatic treatment, said enzymatic treatment comprising contacting the composite material with at least one enzyme to obtain composite material CM3;
wherein the steps a) and b) are performed at least once.

In particular, the glass transition temperature Tg is detected by DSC in accordance ASTM E1356-08(2014).

Accordingly, the epoxy resin C comprises units derived from at least one aromatic compound R1 bearing at least two epoxide groups per molecule and comprising at least one aromatic ring bearing at least one glycidyloxy group, and at least one curing agent R2. In particular, the curing agent R2 is an amine or an imidazole derivative.

Particularly, the reinforcing fibers are carbon fibers.

The method of the invention makes possible the degradation of epoxy composites by a first treatment using a proper solvent, which promotes an increase in the contact surface area of the composite and allows the enhancement of enzymatic degradation of epoxy resin C and the recovery of high quality carbon fibers.

Preferably, the method of the invention comprises a chemical pretreatment wherein the chemical pretreatment of the step a) further comprises step a′) comprising contacting the composite material CM1 with an aqueous solution of phosphoric acid and/or a salt thereof after the composite material CM1 has been contacted with the organic solvent to obtain composite material CM2.

Typically, in step b) the enzyme is a glutathione S-transferase. Particularly, the glutathione S-transferase is issued from a N. aromaticivorans strain.

Advantageously, step b) further comprises contacting the composite material CM1 or CM2 with a para-hydroxybenzoate hydroxylase. Particularly, the para-hydroxybenzoate hydroxylase is a mutated enzyme, preferentially is a mutated enzyme presenting at least two point mutations L199V and Y385F.

Preferably, step b) comprises either the composite material CM1 or CM2 is concomitantly contacted with the glutathione S-transferase and the para-hydroxybenzoate hydroxylase, or the composite material CM1 or CM2 is firstly contacted with the glutathione S-transferase and is thereafter contacted with the para-hydroxybenzoate hydroxylase.

More preferably, enzymatic treatment in step b) is followed by a further step c) submitting the composite material CM3 to a chemical post-treatment comprising contacting the composite material CM3 with an aqueous solution comprising a strong Bronsted base to obtain composite material CM4.

The invention is based on the discovery that the use of a chemical pretreatment involving a proper solvent has affected the degradation of the composite by enhancing the superficial area of the composite material, improving enzyme activity.

Indeed, it has been surprisingly found that the use of the method in which the composite material is submitted to a chemical pretreatment by contacting such a composite material with an organic solvent having a boiling point greater than the glass transition temperature Tg of the composite material at a temperature of at least 100° C. and and exceeding by at least 10° C. the glass transition temperature Tg of the composite material but below the boiling point of the solvent to obtain composite material CM1, allows increased enzymatic degradation of the epoxy resin C using mild conditions without damaging carbon fibers.

A second object of the present invention refers to a method for recovering carbon fibers from a composite material CM said method comprising:
degrading the epoxy resin C comprised in the composite material CM by the method according to step a), and b) and optionally a′) and c), thereby obtaining a composite material CM3 or CM4 comprising carbon fibers and degradation products of the epoxy resin C,
said material CM3 or CM4 being either free of non-degraded epoxy resin C or comprising a remaining fraction of non-degraded epoxy resin C, and;
separating the carbon fibers from the material CM3 or CM4.

A third object of the present invention deals with a method for recycling carbon fibers, comprising:
recovering carbon fibers from a composite material CM by degrading the epoxy resin C comprised in the composite material CM and separating the carbon fibers from the composite material CM3 or CM4 by the method according to the invention; and
forming a composite material CM″, identical to or different from the composite material CM involved in the method according to the invention, said composite material CM″ comprising an epoxy resin C″, identical to or different from the epoxy resin C comprised in the composite material CM, and the recovered carbon fibers.

### 1. Method for Degrading an Epoxy Composite

The method according to the invention comprises at least two steps a) and b) described as follows.

### 1.1 Step a)

Step a) comprises submitting a composite material CM comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1.

Accordingly, step a) comprises submitting the mixture of composite material and organic solvent at a treatment temperature Tₜᵣ of at least 100° C. and exceeding by at least 10° C. the glass transition temperature Tg of the composite material.

The term “glass transition temperature” Tg is the gradual and reversible transition in polymeric materials from a hard and relatively brittle glassy state into a viscous or rubbery state as the temperature is increased. This means is the temperature below which the physical properties of a material change in a manner similar to those of a glassy or crystalline state, and above which they behave like rubbery materials.

The Tg can be determined by any method known to those skilled in the art.

In general, a glass transition temperature Tg can be detected on the composite material by DSC in accordance ASTM E1356-08(2014), so that such glass transition temperature Tg serves as the basis for determining the treatment temperature Tₜᵣ. To determine Tg, a DSC Q2000 calorimeter equipment from TA Instruments is advantageously used. The equipment has been well calibrated with a baseline (empty cell run under the standard DSC program conditions, viz. from room temperature—about 20° C.—to 350° C., with a heat rate of 10° C./min) and with indium calibration (from 100° C. to 180° C. at 10° C./min). A composite material sample is prepared. An appropriate sample mass may be of from about 3 to about 12 mg; it may be adjusted depending on the whole composite material composition, in particular its epoxy content. The sample is advantageously substantially thin and substantially flat so as to ensure good contact with a specimen holder into which it is put. The specimen holder is typically an Aluminium Tzero pan (available from TA Instruments) the lid of which is pierced; the pan is sealed for the test. The sample is heated from room temperature (about 20° C.) to 350° C. using a heating rate of 10° C. Importantly, no cooling program followed by a second heating program is applied: the Tg is determined during the first and only heating program; by doing so, it is avoided to determine the Tg on a sample the crosslinking degree or whatever other structural feature of the epoxy would have been substantially modified upon full completion of this first heating program. The measurement is run under a nitrogen flow gas of 50 mL/min. The midpoint temperature, viz. the point on the thermal curve corresponding to ½ the heat flow difference between the extrapolated onset and extrapolated end, is defined as the glass transition temperature Tg.

Compared to the glass transition temperature Tg of the composite material [as determined by DSC in accordance ASTM E1356-08(2014)], the treatment temperature Tₜᵣ must exceed by at least 10° C. the glass transition temperature Tg of the composite material as determined by DSC in accordance ASTM E1356-08(2014). Tₜᵣ exceeds Tg preferably by at least 20° C., more preferably by at least 30° C. and still more preferably by at least 35° C. Tₜᵣ may exceed Tg by even more Celsius degrees, for example by at least 40° C., or even at least 50° C. Particularly, the Tₜᵣ is at least 100° C., preferably at least 175° C., more preferably at least 200° C.

In rare instances, no glass transition temperature Tg can be detected by DSC in accordance ASTM E1356-08(2014). This situation can notably happen with a few highly crosslinked composite materials. Then, as above explained, the step a) remains applicable subject that the treatment temperature Tₜᵣ satisfies at least one condition chosen from conditions (c1) or (c2).

The Applicant has observed that, for some composite materials, a glass transition temperature T_{g2} could be detected by Dynamic Mechanical Analysis (DMA) in accordance with ASTM D7028-07(2015), while no glass transition temperature Tg could be detected by DSC. Then, the step a) can be applied notably when condition (c1) is satisfied. The condition (c1) requires that the treatment temperature Tₜᵣ exceeds by at least 10° C. the glass transition temperature T_{g2}. In preferred embodiments of (c1), Tₜᵣ exceeds T_{g2} by at least 20° C., more preferably by at least 30° C. and still more preferably by at least 35° C. Tₜᵣ may exceed T_{g2} by even more Celsius degrees, for example by at least 40° C., or even at least 50° C. Besides, Tₜᵣ does not advantageously exceed T_{g2} by more than 200° C., preferably not by more than 100° C., more preferably not by more than 70° C. and still more preferably not by more than 50° C.

For the DMA test, a Q800 dynamic mechanical analyzer from TA Instruments can be used. Flat, clean and dry rectangular strips specimens of a composite material sample are advantageously prepared in accordance with the recommendations of the ASTM standard and the instrument manufacturer's manual. The specimens are properly conditioned to ensure their dryness. Two or more specimens may be tested for each sample, the case being the retained value for T_{g2} shall be the average value of each measurement, subject to possible removal of obviously flaw results. The specimen is placed in the DMA analyzer. Dual cantilever mode is possibly used with a clamp size of 35 mm (L), up to 15 mm (W) and 5 mm (T); in this mode, the specimen is clamped at both ends and flexed in the middle. The specimen is oscillated at a nominal frequency of 1 Hz in constant strain mode. The specimen is heated at a rate of 5° C./min (9° F./min) beginning at room temperature (about 20° C.) to an end temperature at least 50° C. above T_{g2}. Nitrogen may be used as purge gas. The temperature at which a significant drop in storage modulus (E′) begins is assigned as the glass transition temperature (T_{g2} or “DMA Tg”); more precisely, T_{g2} is determined to be the intersection of two tangent lines from the storage modulus.

Advantageously, in step a) the mixture of composite material and organic solvent can be is heated at a temperature of at least 100° C. and exceeding by at least 10° C. the glass transition temperature Tg of the composite material CM but below the boiling point Tb of the solvent.

The term “boiling point” Tb is the temperature at which the vapor pressure of a liquid equals the pressure surrounding the liquid and the liquid changes into a vapor.

The boiling point Tb of different solvents can be predicted by software known in the art. The Applicant has observed that the prediction boiling point of solvents can differ from experimental boiling point from a range of 2 to 25° C. The boiling point Tb of solvents according to the invention were predicted using HSPIP software predicted method version (5.3.06) and are described at Table 1.

Accordingly, in the mixture of the composite material and organic solvent, the organic solvent has a boiling point Tb greater than the glass transition temperature Tg of the composite material CM.

Particularly, the mixture of composite material and organic solvent of step a) can be heated at a temperature of at least 100° C., preferably at least 175° C., more preferably at least 200° C.

In the present invention, the solvent used in step a) promotes the swelling and exfoliation of the composite material CM. Preferably, the exfoliating property of the solvent is better than the swelling property.

By “swelling” it should be understood an enlargement of the structure of the composite material caused by an accumulation of fluid. The extra fluid can lead to an increase in weight of the structure.

As used herein, the term “exfoliation” must be understood as a break at the composite structure in a proper manner producing thin horizontal slices that exposes the interior of the structure, enhancing the overall surface area. The exfoliation is achieved after swelling of the structure.

In very rare instances, no Tg can be detected for a, neither by DSC nor by DMA (this can happen with a few very highly crosslinked composites). In accordance with (c2), then, the treatment shall be operated at a temperature of at least 300° C., preferably at least 350° C., possibly at least 400° C. It can be proceeded by trial and error: if no substantial swelling results at a first treatment, then the treatment can be repeated at a higher temperature, for example at a temperature which is at least 50° C. higher than the temperature that has been used first, etc. until substantial swelling can be achieved by the treatment.

It is self-explicit that the treatment must be operated at a temperature, which is below the boiling point of the solvent. Please note that the predicted boiling point of solvents in accordance with the invention can be up to 431° C. So, proposing a treatment of at least 400°° C. for composites that would be especially resistant against the treatment, makes still sense.

Preferably, the organic solvent in step a) has a boiling point greater than the glass transition temperature of the composite material CM.

According to the step a) of the method of the present invention, exfoliation efficacy of the composite material CM is enhanced by using organic solvents having higher capacity of forming hydrogen bonds.

The Hansen solubility parameter (HSP) is a measure used regularly to characterize the polarity of solvents in terms of their dispersion forces (δ_{D}), the degree of polarity that arises from any dipoles (δ_{P}) and their capacity for hydrogen bonding (δ_{H}). These contain information about the inter-molecular interactions with other solvents and with polymers, pigments, nanoparticles, for example.

The HSP can be determined by different methods known to those skilled in the art. The HSP of solvents according to the invention were predicted by using HSPIP software predicted method version (5.3.06) and results are described in Table 1.

The appropriate solvent, having the HSP value according to the capacity for hydrogen bonding (δ_{H}) allow not only the swelling, but also an enhanced exfoliation of the composite material, increasing the surface area of the composite material.

In particular, the organic solvent is a cyclic solvent chosen from benzyl alcohol, cyrene, N-methyl-pyrrolidone, phenol, 1-naphthol, 2-naphthol, S1, S2, S3, S4, S5, S6, S7, S8, S9, S10, S11, S12, S13, S14, S15, S16, S17 or mixtures thereof, according to structures described in Table 1 below. Preferably, the organic solvent is chosen from benzyl alcohol, cyrene and mixtures thereof. More preferably, the organic solvent is benzyl alcohol.

TABLE 1
Organic solvents structures considered to the method of the present invention.

| Solvent | Structure | δ_{D} | δ_{P} | δ_{H} | Tb (° C.) |
|---|---|---|---|---|---|
| Benzyl alcohol | 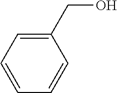 | 18 | 6 | 12.5 | 199 |
| Cyrene | 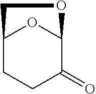 | 18.9 | 12.4 | 7.1 | 204 |
| N-methyl-pyrrolidone | 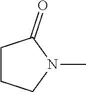 | 17.9 | 9.9 | 7.4 | 204 |
| phenol | 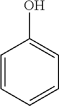 | 18.8 | 5.6 | 11.3 | 187.5 |
| 1-naphthol | 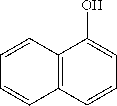 [SMILES: Oc1cccc2ccccc12] | 20.4 | 5.4 | 10.2 | 275.5 |
| 2-naphthol | 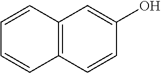 [SMILES: Oc1ccc2ccccc2c1] | 20.4 | 5.4 | 10.2 | 275.5 |
| S1 | 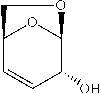 | 18.2 | 7.9 | 12.8 | 190 |
| S2 | 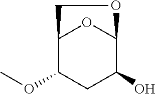 | 17.5 | 8.2 | 10.7 | 222 |
| S3 | 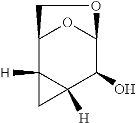 | 18 | 7.8 | 11.3 | 209 |
| S4 | 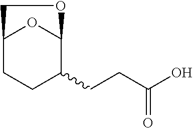 [SMILES: O=C(O)CCC1CC[C@H]2CO[C@@H]1O2] | 17.8 | 7.2 | 10.8 | 313 |
| S5 | 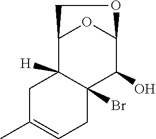 | 18.1 | 7.1 | 9.2 | 316 |
| S6 | 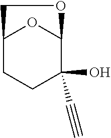 | 18.4 | 8.8 | 11 | 220 |
| S7 | 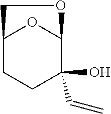 | 18.1 | 7.3 | 9.8 | 218 |
| S8 | 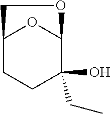 | 17.8 | 7.4 | 9.8 | 221 |
| S9 | 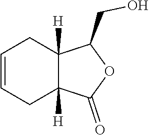 [SMILES: O=C1O[C@H](CO)[C@H]2CC=CC[C@@H]12] | 17.8 | 8.3 | 10.1 | 332 |
| S10 | 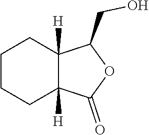 [SMILES: O=C1O[C@H](CO)[C@H]2CCCC[C@@H]12] | 17.2 | 7.6 | 9.6 | 314 |
| S11 | 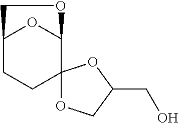 [SMILES: OCC1COC2(CC[C@H]3CO[C@@H]2O3)O1] | 18.4 | 9.4 | 10.3 | 312 |
| S12 | 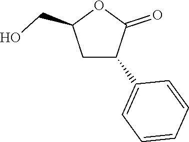 [SMILES: O=C1O[C@H](CO)C[C@H]1c1ccccc1] | 18.3 | 7.3 | 9.7 | 358 |
| S13 | 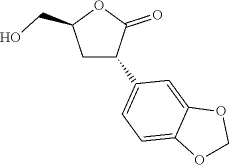 [SMILES: O=C1O[C@H](CO)C[C@H]1c1ccc2c(c1)OCO2] | 19.2 | 7.9 | 10.7 | 431 |
| S14 | 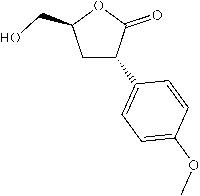 [SMILES: COc1ccc([C@@H]2C[C@@H](CO)OC2=O)cc1] | 18.6 | 7.5 | 9.8 | 398 |
| S15 | 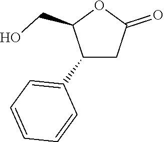 [SMILES: O=C1C[C@H](c2ccccc2)[C@@H](CO)O1] | 18.3 | 7.3 | 9.7 | 358 |
| S16 | 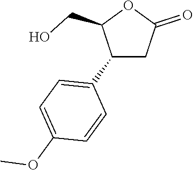 [SMILES: COc1ccc([C@H]2CC(=O)O[C@@H]2CO)cc1] | 18.6 | 7.5 | 9.8 | 398 |
| S17 | 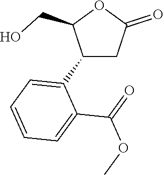 [SMILES: COC(=O)c1ccccc1[C@H]1CC(=O)O[C@@H]1CO] | 18.6 | 8.2 | 9.3 | 404 |

More particularly, step a) comprises submitting a composite material CM comprising an epoxy resin C and reinforcing fibers to a chemical pretreatment, said chemical pretreatment comprising:
a1) forming a mixture M1 comprising the composite material CM and an organic solvent having a boiling point Tb greater than the glass transition temperature Tg of composite material CM, then
a2) maintaining for at least 10 min the mixture M1 at a temperature of at least 100° C. and exceeding by at least 10° C. the glass transition temperature Tg of the composite material CM, so as to allow for the swelling and exfoliation of the epoxy resin C, then
a3) removing the organic solvent from the mixture M1 then obtaining composite material CM1.

The three steps a1), a2), and a3) are successive.

Preferably, step a) is performed without stirring.

Step a) can lasts from 5 hours to 72 hours.

In particular, in step a2) the mixture M1 of composite material CM in the solvent is heated from 2 hours to 5 hours.

In particular, in step a2) the mixture M1 of composite material CM in the solvent is heated at a temperature comprised of at least 100° C., preferably at least 175° C., more preferably at least 200° C.

In particular, in step a3) the organic solvent is removed by filtration.

Advantageously, in step a3) the composite material CM is dried at temperature from 35° C. to 50° C. for 24 hours to several weeks, more preferably for 24 hours to 48 hours.

Advantageously, the weight ratio solvent/composite material CM is comprised between 50 g/g and 200 g/g.

The composite material CM obtained after step a) is called composite material CM1.

Step a) can, optionally be followed by step a′).

Step a′) comprises contacting the composite material CM1 with an aqueous solution of phosphoric acid and/or a salt thereof after the composite material CM has been contacted with the organic solvent.

Step a′) can allow the phosphorylation of the epoxy resin C to some extension.

In the present invention, the solvent to which the composite material is added is chosen among an aqueous solution of phosphoric acid, an aqueous solution of disodium phosphate and a combination thereof. More particularly, the solvent of step a′) is an aqueous solution of disodium phosphate.

Even more particularly, the aqueous solution of disodium phosphate used in step a′) is of a concentration from 120 to 1000 g/L of disodium phosphate, preferably 120 to 500 g/L. Notably, disodium phosphate is used in its form of disodium phosphate anhydrous.

Advantageously, the weight ratio disodium phosphate/composite material CM1 is comprised between 5 and 150 g/g.

Preferably, cyclodextrin is further added to the mixture with composite material in the solvent.

In the present invention, a cyclodextrin is a cyclic oligosaccharide, consisting of a macrocyclic ring of α-D-glucopyranose subunits joined by α-1,4 glycosidic bonds. It is in particular composed of five or more α-D-glucopyranose units linked by 1,4 glycosidic bonds. Cyclodextrin α0 comprises 6 α-D-glucopyranose subunits. Cyclodextrin β comprises 7 α-D-glucopyranose subunits. Cyclodextrin γ comprises 8 α-D-glucopyranose subunits.

Preferably, the cyclodextrin used in step a′) comprises a number of D-glucopyranose subunits ranging from six to eight units in a ring.

More preferably the cyclodextrin is chosen among the group consisting in cyclodextrin α, cyclodextrin β and cyclodextrin γ, even more preferably the cyclodextrin is cyclodextrin β.

Advantageously, the weight ratio cyclodextrin/composite material CM1 is comprised between 0.5 and 50 g/g.

Step a′) is preferably performed under stirring.

Step a′) can lasts from 72 hours to 4 days.

Advantageously, step a′) comprises the following steps:
a′1) forming a mixture M2 comprising the composite material CM1, cyclodextrin and an aqueous solution of phosphoric acid and/or a salt thereof, then
a′2) maintaining for at least 10 min the mixture M2 at a temperature of from 10° C. up to less than 100° C., so as to allow for the phosphorylation of the epoxy resin C, then
a′3) removing water the mixture M2.

The three steps a′1), a′2), a′3) are successive.

In particular, in step a′2) the mixture of composite material CM1 in the solvent and cyclodextrin is stirred for from 36 hours to several weeks, preferably for 36 hours to 72 hours.

In particular, in step a′3) the mixture of composite material CM1 in the solvent is stirred at a temperature comprised between 10° C. and 100° C., preferably between 40° C. and 95° C., more preferably between 55° C. and 90° C.

Particularly, in step a′3) the water is removed by filtration under pressure.

Preferably, in step a′3) the composite material CM1 is dried at temperature from 35° C. to 50° C. for 24 hours to 72hours.

The composite material CM obtained after step a′) is called composite material CM2.

Preferably, the pretreatment of the composite material CM comprises step a) and further step a′) comprising submitting a composite material CM comprising an epoxy resin C and reinforcing fibers to a chemical pretreatment, said chemical pretreatment comprising:
a1) forming a mixture M1 comprising the composite material CM and an organic solvent having a boiling point Tb greater than the glass transition temperature Tg of the composite material CM, then
a2) maintaining for at least 10 min the mixture M1 at a temperature of at least 100° C. and exceeding by at least 10° C. the glass transition temperature Tg of the composite material CM, so as to allow for the swelling and exfoliation of the epoxy resin C, then
a3) removing the organic solvent from the mixture M1 then obtaining composite material CM1.
a′1) forming a mixture M2 comprising the composite material CM1, cyclodextrin and an aqueous solution of phosphoric acid and/or a salt thereof, then
a′2) maintaining for at least 10 min the mixture M2 at a temperature of from 10° C. up to less than 100° C., so as to allow for the phosphorylation of the epoxy resin C, then
a′3) removing water from the mixture M2 to obtain composite material CM2.

### 1.2 Step b)

Step b) comprises treating enzymatically the composite material CM obtained after step a) or a′), the treatment comprising a step of contacting the composite material CM2 or CM1 with at least one enzyme to obtain a mixture M3. Preferably, the composite material used in step b) is composite material CM2.

Particularly, the enzymatic treatment is performed by contacting composite material CM1 or CM2 with the enzyme glutathione S-transferase (GST).

In the sense of the invention, a “glutathione S-tranferase” (GST) is an enzyme having the ability to catalyze the depolymerization reaction of the epoxy resin C in which n>m, by cleaving the epoxy resin and using reduced glutathione (GSH) as a cofactor, as presented schematically below:

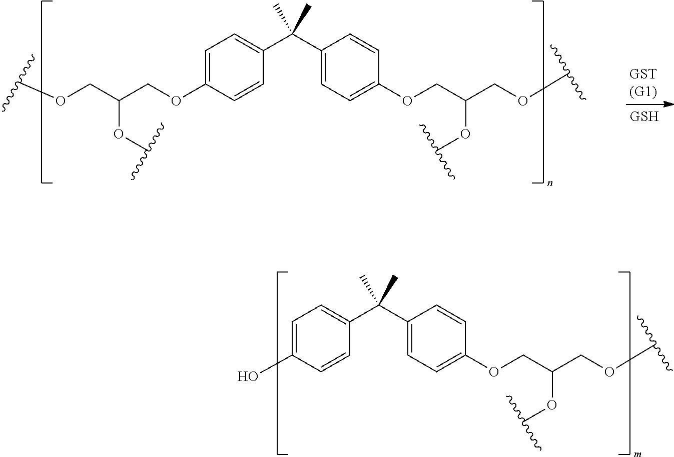

In the normalized nomenclature, these enzymes are classified as members of EC 2.5.1.18.

The glutathione S-transferases (GSTs) used in the method of the invention may be of eukaryotic or prokaryotic origin, preferentially is of prokaryotic origin.

Among the superfamily of GSTs, a subclass of stereospecific glutathione S-transferases called β-etherases are of particular interest for the method of the invention.

In particular, the enzymes LigE, LigP, and LigF issued from Sphingobium sp. and their homologs may be used. Among the homologs easily identified by the man skilled in the art, one can cite the enzymes LigE-NS (=NsLigE) and LigF-NS from Novosphingobium sp.PP1Y, LigE-NA (=NaLigE), LigF-NA (=NaLigF1) and NaLigF2 from Novosphingobium aromaticivorans DSM12444.

In a specific implementation of the method, the glutathione S-transferase used in step b) is a β-etherase. In particular, the GST used in step b) is an enzyme LigE, LigP or LigF issued from Sphingobium sp, or any homolog of these enzymes, for example LigD, LigL, LigN, LigO or LigG. Preferentially, the GST used in step b) is a LigE homolog.

In a specific implementation of the method of the invention, in step b), the glutathione S-transferase is issued from Novosphingobium aromaticivorans (N. aromaticivorans) strain. The glutathione S-transferase may be in particular a LigE homolog issued from Novosphingobium aromaticivorans strain, i.e. LigE-NA.

In particular, the glutathione S-transferase can be immobilized on a suitable solid support.

Advantageously, the glutathione S-transferase is added to the composite material CM1 or CM2 in the form of a broth of lysed bacteria expressing glutathione S-transferase. The bacteria are as described above. The broth of lysed bacteria is obtained by cultivation of bacteria as described above followed by centrifugation to obtain cell pellets, then cell pellets are mixed with phosphate buffer (0.1M pH=7.0) in a proportion of 1 g (of pellets)/10 ml (of buffer) and bacteria are lysed by sonication.

The broth obtained from the bacteria lysis contains the glutathione S-transferase. At least 1 vol. % of this solution can be used, preferably from 1 vol. % to 20 vol. % can be used.

In particular, in step b), the composite material CM1 or CM2 is contacted with a glutathione S-transferase in appropriate medium.

In particular the appropriate medium is aqueous medium comprising glutathione S-transferase in the buffer described above.

Advantageously, the weight ratio glutathione S-transferase cell pellets/composite material CM1 or CM2 in the appropriate medium is comprised between 0.5 g/g and 10 g/g.

Preferably, the appropriate medium has a pH comprised between 6 and 11, more preferably between 8 and 10.

Preferably, the composite material CM1 or CM2 is contacted with glutathione S-transferase for at least 50 hours, more preferably at least 72 hours.

In particular, the composite material CM1 or CM2 is contacted with glutathione S-transferase at a temperature comprised between 20° C. and 45° C.

Advantageously, the composite material CM1 or CM2 is further contacted with aqueous medium of reduced glutathione, glycine and optionally an aqueous medium of cyclodextrin.

Advantageously, the weight ratio reduced glutathione/composite material CM1 or CM2 in the aqueous medium is comprised between 0.1 g/g and 50 g/g.

Advantageously, the weight ratio glycine/composite material CM1 or CM2 in the aqueous medium is comprised between 1 g/g and 100 g/g.

Thus, in step b) composite material CM1 or CM2 is contacted with aqueous medium of reduced glutathione, glycine, glutathione S-transferase in appropriate medium and optionally aqueous medium of cyclodextrin, preferably at a pH comprised between 8 and 10, preferably at a temperature comprised between 20° C. and 45° C., and preferably for at least 50 hours.

In particular, step b) comprises the following steps:
b1) adding in a reactor, preferably successively, composite material CM1 or CM2, reduced glutathione, glycine, glutathione S-transferase in appropriate medium and optionally cyclodextrin, and
b2) stirring the mixture obtained after step b1) for at least 50 hours at a temperature comprises between 20° C. and 45° C.;
b3) optionally filtering and washing, and then
b4) optionally drying under heating.

The four steps b1), b2), and optionally b3) and b4) are successive.

The mixture obtained after step b1) corresponds to the composite material CM1 or CM2 contacted to the glutathione S-Transferase in the appropriate medium mentioned above.

The mixture obtained after step b) is called mixture M3.

Resulting mixture M3 has a pH comprised between 8 and 10.

Preferably, in step b4) the composite material CM1 or CM2 is dried at temperature from 35°° C. to 50° C. for 24 hours to 72 hours.

The composite material CM obtained after step c) is called composite material CM3.

Advantageously, step b) further comprises contacting the composite material CM1 or CM2 with a para-hydroxybenzoate hydroxylase (PHBH) to obtain a mixture M3.

In the sense of the invention, a para-hydroxybenzoate hydroxylase (PHBH), classified as EC 1.14.13.2, is a flavoprotein involved in degradation of aromatic compounds. The cofactor NADP is involved in the reaction as an acceptor of hydrogen, and is transformed into NADPH during the reaction. In step b), this enzyme catalyzes, together with its cofactor FAD, the addition of hydroxyl groups over the aromatic moieties, highly present in resin structure, as presented schematically below:

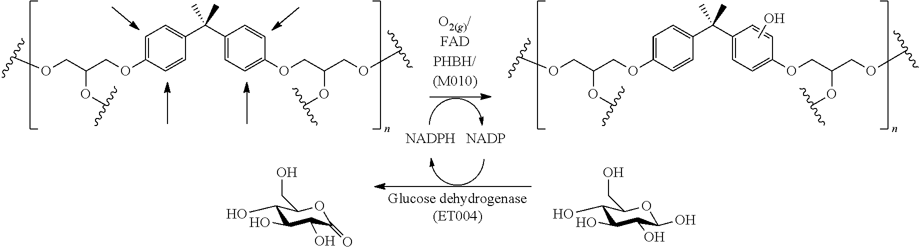

Therefore, this reaction allows an oxidation of the resin. The resin is then more hydrophilic, and its solubility in aqueous medium is enhanced. Moreover, these hydroxylated moieties are more susceptible to the cleavage performed in step c).

In a preferred embodiment, the para-hydroxybenzoate hydroxylase (PHBH) used in step b) is issued from Pseudomonas aeruginosa.

Alternatively, the para-hydroxybenzoate hydroxylase (PHBH) used in step b) can be issued from Corynebacterium glutamicum.

The PHBH enzyme used in step b) may be a wild-type enzyme or a mutated one.

In a preferred embodiment of the invention, PHBH used in step b) is a mutated enzyme, even more preferentially it is a mutated enzyme presenting at least two point mutations L199V and Y385F, according to the following:
the mutated PHBH enzyme issued from Pseudomonas aeruginosa, modified with two point mutations: L199V and Y385F (designated in the examples as “M010”).

In an alternative embodiment, PHBH used in step b) can be a mutated enzyme presenting at least two point mutations L200V and Y385F, according to the following:
the mutated PHBH enzyme issued from Corynebacterium glutamicum, modified with both point mutations: L200V and Y385F (designated in the examples as “YM321”), or
the mutated PHBH enzyme issued from Corynebacterium glutamicum, modified with three point mutations: L200V, Y385F and D39Y (designated in the examples as “YM322”).

In particular, the PHBH can be immobilized on a suitable solid support.

Advantageously, the PHBH is added to the composite material CM1 or CM2 in the form of a broth of lysed bacteria expressing PHBH. The bacteria are as described above. The broth of lysed bacteria is obtained by cultivation of bacteria as described above followed by centrifugation to obtain cell pellets, then cell pellets are mixed with phosphate buffer (0.1M pH=7.0) in a proportion of 1 g (of pellets)/10 ml (of buffer) and bacteria are lysed by sonication.

The broth obtained from the bacteria lysis contains the PHBH. At least 1 vol. % of this solution can be used, preferably from 1 vol. % to 20 vol. % can be used.

In particular, in step b), the composite material CM1 or CM2 is contacted with a PHBH in an appropriate medium, in particular in the buffer aqueous medium described above.

Preferably, the appropriate medium has a pH comprises between 6 and 11, more preferably between 8 and 10.

Advantageously, in step b) the composite material CM1 or CM2 is further contacted with an aqueous system comprising cofactors nicotinamide adenine dinucleotide phosphate (NADP) and flavine adenine dinucleotide (FAD).

Advantageously, the aqueous system comprises compounds allowing the regeneration of the cofactors NADP. Means for the regeneration of NADP are well known by the man skilled in the art. In particular, the aqueous system comprises glucose and an enzyme with glucose dehydrogenase activity, which reduces NADP⁺ to NADPH while oxidizing glucose-6-phosphate (classified in EC 1.1.1.49). The man skilled in the art knows well these enzymes and will be able to choose one glucose dehydrogenase such as ET004.

In particular, the aqueous medium further contacting the composite material CM1 or CM2 comprises glucose dehydrogenase such as ET004.

Preferably, step b) is performed by contacting the composite material CM1 or CM2 concomitantly with the glutathione S-transferase (GST) and the para-hydroxybenzoate hydroxylase (PHBH).

Alternatively, the enzymatic treatment is performed by contacting the composite material CM1 or CM2 firstly with the glutathione S-transferase (GST) and thereafter with the para-hydroxybenzoate hydroxylase (PHBH).

In particular, the weight ratio GST cell pellets/composite material CM1 or CM2 in the appropriate medium is comprised between 0.5 g/g and 10 g/g.

In particular, the weight ratio PHBH cell pellets/composite material CM1 or CM2 in the appropriate medium is comprised between 0.5 g/g and 10 g/g.

Preferably, the appropriate medium has a pH comprised between 6 and 11, more preferably between 8 and 10.

Preferably, composite material CM1 or CM2 is contacted concomitantly with GST and PHBH for at least 50 hours.

In particular, composite material CM1 or CM2 is contacted concomitantly with GST and PHBH at a temperature comprised between 20° C. and 45° C.

Preferably, the composite material CM1 or CM2 is further contacted with aqueous medium of reduced glutathione, glycine and optionally an aqueous medium of cyclodextrin.

Advantageously, the weight ratio reduced glutathione/composite material CM1 or CM2 in the appropriate medium is comprised between 0.1 g/g and 50 g/g.

Advantageously, the weight ratio glycine/composite material CM1 or CM2 in the appropriate medium is comprised between 1 g/g and 100 g/g.

Preferably, the composite material CM1 or CM2 is further contacted with aqueous medium comprising NADP. More preferably, the weight ratio NADP/composite material CM1 or CM2 in the aqueous medium is comprised between 0.001 g/g and 1 g/g.

Advantageously, the composite material CM1 or CM2 is further contacted with aqueous medium comprising FAD. In particular, the weight ratio FAD/composite material CM1 or CM2 in the aqueous medium is comprised between 0.0001 g/g and 1 g/g.

Preferably, the composite material CM1 or CM2 is further contacted with ET004 in appropriate medium. More particularly, the weight ratio of ET004 cell pellets/composite material CM1 or CM2 is comprised between 0.5 g/g and 10 g/g.

Thus, in a preferred embodiment, the composite material CM1 or CM2 is contacted concomitantly with GST and PHBH in appropriate medium, aqueous medium of reduced glutathione, glycine and glucose, aqueous medium of NADP and FAD, ET004 in appropriate medium, and optionally aqueous medium of cyclodextrin preferably at a pH comprised between 8 and 10, preferably at a temperature comprised between 20° C. and 45° C., and preferably for at least 50 hours.

In a particular preferred embodiment, step b) comprises the following steps:
b1) adding in a reactor, preferably successively, composite material CM1 or CM2, reduced glutathione, glycine, glucose, NADP, FAD and GST, PHBH and ET004 in appropriate mediums, and optionally cyclodextrin, and
b2) stirring the mixture obtained after step b1) for at least 50 hours at a temperature comprises between 20° C. and 45° C.;
b3) optionally filtering and washing, and then
b4) optionally drying under heating.

The four steps b1), b2), and optionally b3) and b4) are successive.

The mixture obtained after step b1) corresponds to the composite material CM1 or CM2 contacted concomitantly with GST and PHBH in the appropriate mediums mentioned above.

The mixture obtained after step b) is called mixture M3.

Resulting mixture M3 has a pH comprised between 8 and 10.

Preferably, in step b4) the composite material CM1 or CM2 is dried at temperature from 35° C. to 50° C. for 24 hours to 72hours.

The composite material CM obtained after step c) is called composite material CM3.

In an alternative embodiment, the method according to the invention, step b) is performed by contacting the composite material CM1 or CM2 firstly with the glutathione S-transferase (GST) and thereafter with the para-hydroxybenzoate hydroxylase (PHBH).

In particular, the weight ratio GST cell pellets/composite material CM1 or CM2 in the appropriate medium is comprised between 0.5 g/g and 10 g/g.

In particular, the weight ratio PHBH cell pellets/composite material CM1 or CM2 in the appropriate medium is comprised between 0.5 g/g and 10 g/g.

Preferably, the appropriate medium has a pH comprised between 6 and 11, more preferably between 8 and 10.

Preferably, composite material CM1 or CM2 is contacted with GST and thereafter with PHBH for at least 50 hours more preferably at least 72 hours.

In particular, composite material CM1 or CM2 is contacted with GST and thereafter with PHBH at a temperature comprised between 20° C. and 45° C.

Advantageously, the weight ratio reduced glutathione/composite material CM1 or CM2 in the appropriate medium is comprised between 0.1 g/g and 50 g/g.

Advantageously, the weight ratio glycine/composite material CM1 or CM2 in the appropriate medium is comprised between 1 g/g and 100 g/g.

Preferably, the composite material CM1 or CM2 is further contacted with aqueous medium comprising NADP. More preferably, the weight ratio NADP/composite material CM1 or CM2 in the appropriate medium is comprised between 0.001 g/g and 1 g/g.

Advantageously, the composite material CM1 or CM2 is further contacted with aqueous medium comprising FAD. In particular, the weight ratio FAD/composite material CM1 or CM2 in the appropriate medium is comprised between 0.0001 g/g and 1 g/g.

Preferably, the composite material CM1 or CM2 is further contacted with ET004 in appropriate medium. More particularly, the weight ratio of ET004 cell pellets/composite material CM1 or CM2 is comprised between 0.5 g/g and 10 g/g.

Thus, in a second embodiment, the composite material CM1 or CM2 is contacted with a GST in appropriate medium, aqueous medium of reduced glutathione, glycine and glucose, ET004 in appropriate medium and further PHBH in appropriate mediums, and aqueous medium of NADP and FAD and optionally aqueous solution of cyclodextrin, preferably at a pH comprised between 8 and 10, preferably at a temperature comprised between 20° C. and 45° C., and preferably for at least 50 hours

In a second embodiment, step b) comprises the following steps:
b1) adding in a reactor, preferably successively, composite material CM1 or CM2, reduced glutathione, glycine and glucose, GST in appropriate medium and optionally cyclodextrin, and
b2) adding NADP and FAD, PHBH and ET004 in appropriate mediums, and
b3) stirring the mixture obtained after step b2) for at least 50 hours at a temperature comprises between 20° C. and 45° C.,
b4) optionally filtering and washing, and then
b5) optionally drying under heating.

The five steps b1), b2), b3) and optionally b4) and b5) are successive.

The mixture obtained after step b2) corresponds to the composite material CM1 or CM2 contacted with a GST and further with a PHBH in the appropriate mediums mentioned above.

The mixture obtained after step b) is called mixture M3.

Resulting mixture M3 has a pH comprised between 8 and 10.

Preferably, in step b4) the composite material CM1 or CM2 is dried at temperature from 35° C. to 50° C. for 24 hours to 72hours.

The composite material CM obtained after step c) is called composite material CM3.

### 1.3 Step c)

Step b) is optionally followed by step c).

Step c) comprises a chemical post-treatment of the composite material CM3, the chemical post-treatment comprising a step of contacting the composite material CM3 with an aqueous solution comprising a strong Bronsted base.

Indeed, step c) is performed after enzymatic treatment step b).

In step c) the strong Bronsted base can promote additional degradation due to cleavage of the epoxy resin.

In a particular embodiment, the strong Bronsted base is selected from hydroxides of alkali metals and alkaline earth metals such as sodium hydroxide, lithium hydroxide or potassium hydroxide. Preferably, the strong Bronsted base is sodium hydroxide.

Preferably, the strong Bronsted base is in a concentration comprised between 0.1 mol/L and 10 mol/L, more preferably between 1 mol/L and 10 mol/L.

Advantageously, the weight ratio (aqueous solution of a strong Bronsted base)/composite material CM3 is comprised between 10 g/g and 100 g/g.

Advantageously, in a preferred embodiment, in step c) composite material CM3 is in contact with the aqueous solution comprising a strong Bronsted base for 48 hours to 2 weeks at a temperature comprised between 20° C. and 100° C., more advantageously at a temperature between 60° C. and 100° C.

Advantageously, step c) comprises the following steps:
c1) contacting composite material CM3 with aqueous solution comprising a strong Bronsted base,
c2) heating, then
c3) optionally filtering and washing, and then
c4) optionally drying under heating.

Preferably, step c2) is performed under stirring.

Preferably, in step c4) the composite material CM3 is dried at temperature from 35° C. to 50° C. for 24 hours to 72 hours.

The composite material CM obtained after step c) is called composite material CM4.

### 2. Rounds

The method according to the invention can be reproduced several times, preferably at least one time, more preferably at least two times.

The method of the invention can be reproduced between one time and 30 times, preferably between one time and 20 times, more preferably one time and ten times.

A first round of the method according to the invention corresponds to:
a) submitting a composite material CM comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1,
a′) optionally contacting the composite material CM1 with an aqueous solution of phosphoric acid and/or a salt thereof to obtain composite material CM2;
b) submitting the composite material obtained after the step a) or a′) to an enzymatic treatment, said enzymatic treatment comprising contacting the composite material with at least one enzyme to obtain composite material CM3;
c) optionally contacting the composite material CM3 with an aqueous solution comprising a strong Bronsted base to obtain composite material CM4.

The composite material obtained after performing a first round of the method according to the invention can be submitted again to the method according to the invention and thus replace the composite material CM in step a). A second round of the method according to the invention is then performed.

Thus, the second round corresponds to:
a) submitting the composite material CM obtained after first round comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1′;
a′) optionally contacting the composite material CM1′ with an aqueous solution of phosphoric acid and/or a salt thereof to obtain composite material CM2′;
b) submitting the composite material obtained after the step a) or a′) to an enzymatic treatment, said enzymatic treatment comprising contacting the composite material with at least one enzyme to obtain composite material CM3′;
c) optionally contacting the composite material CM3′ with an aqueous solution comprising a strong Bronsted base to obtain composite material CM4′.

The composite material obtained after performing a first round of the method according to the invention can be composite material CM3 or composite material CM4 as defined above. Preferably, it corresponds to composite material CM4.

In particular, more than two rounds can be performed, more particularly more than three rounds can be performed. Preferably, from 1 to 30 rounds can be performed, more preferably from 2 to 20 rounds, even more preferably from 2 to 10 rounds.

Advantageously, one to ten rounds of the method according to the invention can be performed.

### 3. Epoxy Composites

The method according to the invention aims at degrading epoxy composites.

The epoxy composite used in the method of the invention comprises an epoxy resin C and reinforcing fibers.

Particularly, epoxy resin C comprises units derived from:
at least one aromatic compound R1 bearing at least two epoxide groups per molecule, and at least one aromatic ring bearing at least one glycidyloxy group, and
at least one curing agent R2,
optionally an additional compound R3.

The expression “epoxy resin comprising units derived from” should, of course, be understood as meaning an epoxy resin comprising the mixture and/or the reaction product of the various base constituents used for this composition, it being possible for some of them to be intended to react or capable of reacting with one another or with their immediate chemical surroundings, at least partly, during the various phases of manufacture of the epoxy resin, or of the composites or finished articles comprising such composites, in particular during a curing step. In other words, the epoxy resin C is manufactured from at least one aromatic compound R1 as described below and at least one curing agent R2.

Advantageously, the epoxy resin C comprises units derived from one aromatic compound R1 and one curing agent R2.

As used herein in reference to an organic compound, the term “aromatic” means that the organic compound that comprises one or more one aryl moieties, which may each optionally be interrupted by one or more heteroatoms, typically selected from oxygen, nitrogen, and sulfur heteroatoms, and one or more of the carbon atoms of one or more one aryl moieties may optionally be substituted with one or more organic groups, typically selected from alkyl, alkoxyl, hydroxyalkyl, cycloalkyl, alkoxyalkyl, haloalkyl, aryl, alkaryl, aralkyl.

As used herein, the term “aryl” means cyclic, coplanar 5-to 14-membered organic group having a delocalized, conjugated IT system, with a number of TT electrons that is equal to 4n+2, where n is 0 or a positive integer, including compounds where each of the ring members is a carbon atom, such as benzene, compounds where one or more of the ring members is a heteroatom, typically selected from oxygen, nitrogen and sulfur atoms, such as furan, pyridine, imidazole, and thiophene, and fused ring systems, such as naphthalene, anthracene, and fluorene, wherein one or more of the ring carbons may be substituted with one or more organic groups, typically selected from alkyl, alkoxyl, hydoxyalkyl, cycloalkyl, alkoxyalkyl, haloalkyl, aryl, alkaryl, halo groups, such as, for example, phenyl, methylphenyl, trimethylphenyl, nonylphenyl, chlorophenyl, or trichloromethylphenyl.

As used herein, “epoxide group” means a vicinal epoxy group, i.e., a 1,2-epoxy group.

### 3.1. Aromatic Compound R1

The first essential compound of the epoxy resin C is an aromatic compound R1 bearing at least two epoxide groups per molecule and comprising at least one aromatic ring bearing at least one glycidyloxy group.

The aromatic compound R1 according to the invention bears at least two epoxide groups per molecule, and one of the at least two epoxide groups might be the epoxide group from the glycidyloxy group bore by the aromatic ring bearing at least one glycidyloxy group.

In particular suitable aromatic compounds R1 include polyglycidyl ethers of phenols and of polyphenols, such as diglycidyl resorcinol, 1,2,2-tetrakis (glycidyloxyphenyl) ethane, or 1,1,1-tris (glycidyloxyphenyl)methane, diglycidyl ether of bisphenol, such as diglycidyl ether of bisphenol A (bis(4-hydroxyphenyl)-2,2-propane), diglycidyl ether of bisphenol F (bis(4-hydroxyphenyl)methane), diglycidyl ether of bisphenol C (bis(4-hydroxyphenyl)-2,2-dichloroethylene), and diglycidyl ether of bisphenol S (4,4′-sulfonyldiphenol), including oligomers thereof, polyglycidyl ethers of aromatic alcohols, epoxidized novolac compounds, epoxidized cresol novolac compounds, polyglycidyl ether of aminophenols such as triglycidyl aminophenols (TGAP), triglycidyl aminocresol.

Preferably, suitable aromatic compounds R1 include known, commercially available compounds, such as triglycidyl ethers of p-aminophenol (such as MY 0510 from Hunstman); triglycidyl ethers of m-aminophenol (such as MY 0610 from Hunstman); diglycidyl ethers of bisphenol A based materials such as 2,2-bis(4,4′-dihydroxy phenyl) propane (such as DER 661 from Dow, or EPON 828 from Momentive); glycidyl ethers of phenol Novolac resins (such as. DEN 431 or DEN 438 from Dow); diglycidyl derivative of dihydroxy diphenyl methane (such as PY 306 from Huntsman).

Advantageously, the aromatic compound R1 corresponds to a diglycidyl ether of bisphenol, such as diglycidyl ether of bisphenol A (bis(4-hydroxyphenyl)-2,2-propane), diglycidyl ether of bisphenol F (bis(4-hydroxyphenyl)methane), diglycidyl ether of bisphenol C (bis(4-hydroxyphenyl)-2,2-dichloroethylene), and diglycidyl ether of bisphenol S (4,4′-sulfonyldiphenol).

In particular the aromatic compound R1 corresponds to a bisphenol A diglycidyl ether.

### 3.2 Curing Agent R2

The second essential compound of the epoxy resin C is the curing agent R2.

Curing agents of epoxy resins are well known to one skilled in the art.

It can be an amine, such as a primary amine, a secondary amine, or a tertiary amine, a ketimine, a polyamide resin, an imidazole derivative, a polymercaptan, an anhydride, a boron-trifluoride-amine complex, a dicyandiamide, an organic acid hydrazide, a photocuring agent or an ultraviolet-curing agent.

In particular, amine as curing agent is a polyamine. It can be an aliphatic polyamine or an aromatic amine.

Suitable amine as curing agent include diethylenetriamine (DTA), triethylenetetramine (TTA), tetraethylenepentamine (TEPA), dipropenediamine (DPDA), diethylaminopropylamine (DEAPA), amine 248, N-aminoethylpiperazine (N-AEP), Lamiron C-260, Araldit HY-964, menthan diamine (MDA), isophoronediamine (IPDA), S cure 211, Wandamin HM, 1.3 BAC, m-xylenediamine (m-XDA), Sho-amine X, Amine black, Sho-amine black, Sho-amine N, Sho-amine 1001, Sho-amine 1010, metaphenylene diamine (MPDA), diaminodiphenylmethane (DDM), diaminodiphenylsulfone (DDS), 4,4′-methylenebis(2,6-diethylaniline.

Suitable imidazole derivative as curing agent R2 include 2-methylimidazole, 2-phenyl-imidazole, 3-benzyl-2-methylimidazole, 5-methyl-2-phenylimidazole, 2-ethyl-4-methylimidazole, 5-ethyl-2-methylimidazole or 1-cyanoethyl-2-undecylimidazolium trimellitate.

Suitable anhydride as curing agent R2 include phthalic anhydride, trimellitic anhydride, pyromellitic anhydride, benzophenone tricarboxylic anhydride, ethylene glycol bistrimellitate, glycerol tristrimellitate, maleic anhydride, tetrahydrophthalic anhydride, enomethylene tetrahydrophthalic anhydride, methylendomethyldene tetrahydrophthalic anhydride, dodecenyl succinic anhydride, hexahydrophthalic anhydride, hexahydro-4-methylphthalic anhydride, succinic anhydride, methylcyclohexene dicarboxylic anhydride, alkylstryrene-maleic anhydride copolymer, chlorendic anhydride, polyazelaic polyanhydride.

Preferably, the curing agent R2 is chosen from a primary amine and an imidazole derivative.

### 3.3 Additional Compound R3

The epoxy resin C can also comprise units derived from at least one epoxy compound that has at least two epoxide groups per molecule. Suitable epoxy compounds include aromatic epoxy compounds, epoxy compounds, alicyclic epoxy compounds, and epoxy compounds.

Suitable aromatic epoxy compounds include aromatic compounds having two or more epoxide groups per molecule, including known compounds such as, for example: polyglycidyl ethers of phenols and of polyphenols, such as diglycidyl resorcinol, 1,2,2-tetrakis(glycidyloxyphenyl) ethane, or 1,1,1-tris(glycidyloxyphenyl)methane, the diglycidyl ethers of bisphenol A (bis(4-hydroxyphenyl)-2,2-propane), bisphenol F (bis(4-hydroxyphenyl)methane), bisphenol C (bis(4-hydroxyphenyl)-2,2-dichloroethylene), and bisphenol S (4,4′-sulfonyldiphenol), including oligomers thereof, fluorene ring-bearing epoxy compounds, naphthalene ring-bearing epoxy compounds, dicyclopentadiene-modified phenolic epoxy compounds, epoxidized novolac compounds, and epoxidized cresol novolac compounds, polyglycidyl adducts of amines, such as N,N-diglycidyl aniline, N,N,N′,N′-tetraglycidyl diaminodiphenylmethane (TGDDM), triglycidyl aminophenols (TGAP), triglycidyl aminocresol, or tetraglycidyl xylenediamine, or amino alcohols, such as triglycidyl aminophenol, polyglycidyl adducts of polycarboxylic acids, such as diglycidyl phthalate, polyglycidyl cyanurates, such as triglycidyl cyanurate, copolymers of glycidyl(meth)acrylates with copolymerizable vinyl compounds, such as styrene glycidyl methacrylate.

Suitable epoxy compounds having two or more epoxide groups per molecule include known, commercially available compounds, such as N,N,N′,N′-tetraglycidyl diamino diphenylmethane (such as MY 9663, MY 720, and MY 721 from Huntsman), N,N,N′,N′-tetraglycidyl-bis(4-aminophenyl)-1,4-diiso-propylbenzene (such as EPON 1071 from Momentive); N,N,N′,N′-tetraclycidyl-bis(4-amino-3,5-dimethylphenyl)-1,4-diisopropylbenzene, (such as EPON 1072 from Momentive); triglycidyl ethers of p-aminophenol (such as MY 0510 from Hunstman); triglycidyl ethers of m-aminophenol (such as MY 0610 from Hunstman); diglycidyl ethers of bisphenol A based materials such as 2,2-bis(4,4′-dihydroxy phenyl) propane (such as DER 661 from Dow, or EPON 828 from Momentive, and Novolac resins preferably of viscosity 8-20 Pa·s at 25° C.; glycidyl ethers of phenol Novolac resins (such as. DEN 431 or DEN 438 from Dow); di-cyclopentadiene-based phenolic novolac (such as Tactix® 556 from Huntsman); diglycidyl 1,2-phthalate; diglycidyl derivative of dihydroxy diphenyl methane (such as PY 306 from Huntsman).

Suitable alicyclic epoxy compounds having two or more epoxide groups per molecule, including known compounds such as, for example, bis(2,3-epoxy-cyclopentyl)ether, copolymers of bis(2,3-epoxy-cyclopentyl)ether with ethylene glycols, dicyclopentadiene diepoxide, 4-vinyl cyclohexene dioxide, 3,4-epoxycyclohexylmethyl, 3,4-epoxycyclohexane carboxylate, 1,2,8,9-diepoxy limonene (limonene dioxide), 3,4-epoxy-6-methyl-cyclohexylmethyl, 3,4-epoxy-6-methylcyclohexane carboxylate, bis(3,4-epoxy-6-methylcyclohexylmethyl)adipate, 2-(7-oxabicyclo[4.1.0]hept-3-yl)spiro[1,3-dioxane-5,3′-[7]oxabicyclo[4.1.0]heptane], diepoxides of allyl cyclopentenyl ether, 1,4-cyclohexadiene diepoxide, 1,4-cyclohexanemethanol diglydical ether, bis(3,4-epoxycyclohexylmethyl) adipate, 3,4-epoxy-6-methylcyclohexane carboxylate, diglycidyl 1,2-cyclohexane carboxylate, 3,4-epoxycyclohexylmethyl methacrylate, 3-(oxiran-2-yl)-7-oxabicyclo[4.1.0]heptane, bis(2,3-epoxypropyl)cyclohex-4-ene-1,2-dicarboxylate, 4,5-epoxytetrahydrophthalic acid diglycidyl ester, poly[oxy(oxiranyl-1,2-cyclohexanediyl)] α-hydro-ω-hydroxy-ether, bi-7-oxabicyclo[4.1.0]heptane.

Suitable aliphatic epoxy compounds having two or more epoxide groups per molecule, including known compounds such as, for example: butanediol diglycidyl ether, epoxidized polybutadiene, dipentene dioxide, trimethylolpropane triglycidyl ether, bis[2-(2-butoxyethyoxy)ethyl)ethyl]adipate, hexanediol diglycidyl ether, and hydrogenated bisphenol A epoxy resin.

Suitable alicyclic epoxy compounds and aliphatic epoxy compounds include known, commercially available compounds, such as, for example: 3′,4′-epoxycyclohexanemethyl-3,4-epoxycyclohexylcarboxylate (CELLOXIDE™ 2021P resin (Daicel Corporation) and ARADITE CY 179 (Huntsman Advanced Materials)), bi-7-oxabicyclo[4.1.0]heptane (CELLOXIDE™ 8010 (Daicel Corporation)) 3:1 mixture of poly [oxy (oxiranyl-1,2-cyclohexanediyl)], α-hydro-ω-hydroxy-ether with 2-ethyl-2-(hydroxymethyl)-1,3-propanediol (EHPE 3150 (Daicel)).

The epoxy resin may optionally further comprise units derived from one or more monoepoxide compounds having one epoxide group per molecule, selected from aromatic monoepoxy compounds, monoalicyclic epoxy compounds, and aliphatic monoepoxy compounds. Suitable monoepoxide compounds, including known compounds such as, for example: saturated alicylic monoepoxides, such as 3,3′-bis(chloromethyl)oxacyclobutane, isobutylene oxide, styrene oxide, olefinic monoepoxides, such as cyclododecadiene monoepoxide, 3,4-epoxy-1-butene.

### 4. Method for Recovering

The present invention also refers to a method for recovering carbon fibers from a composite material CM said method comprising:
degrading the epoxy resin C comprised in the composite material CM by the method according to step a), and b) and optionally a′) and c), thereby obtaining a composite material CM3 or CM4 comprising carbon fibers and degradation products of the epoxy resin C,
said material CM3 or CM4 being either free of non-degraded epoxy resin C or comprising a remaining fraction of non-degraded epoxy resin C, and;
separating the carbon fibers from the material CM3 or CM4.

Preferably, the composite material used in the method for recovering carbon fibers is the composite material CM4.

A composite material is a material made from two or more constituent materials with significantly different physical or chemical properties that, when combined, produce a material with characteristics different from the individual components. Thus, typically, a composite material comprises a matrix and reinforcement.

The reinforcement is preferably reinforcing fibers. It can be mineral, organic or plant fibers, notably glass fibers or carbon fibers. More preferably, the reinforcement is carbon fibers.

In the present invention, the composite material comprises reinforcing fibers comprising carbon fibers and a matrix which comprises at least one epoxy resin C as described above.

Typically, the degradation process of a composite material aims recovering the higher value component, the carbon fibers.

The method for recovering carbon fibers from a composite material CM according to the invention allows then to recover high quality carbon fibers from a composite material.

Thus, the method for recovering carbon fibers from a composite material CM comprises a step of degrading the composite material comprising:
a) submitting a composite material CM comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1,
a′) optionally contacting the composite material CM1 with an aqueous solution of phosphoric acid and/or a salt thereof to obtain composite material CM2;
b) submitting the composite material obtained after the step a) or a′) to an enzymatic treatment, said enzymatic treatment comprising contacting the composite material with at least one enzyme to obtain composite material CM3;
c) optionally contacting the composite material CM3 with an aqueous solution comprising a strong Bronsted base to obtain composite material CM4;

Advantageously, the composite material CM comprises carbon fibers. Thus, in step b) or c), the composite material CM3 or CM4 with a reduced content in epoxy resin C is obtained, and carbon fibers can be isolated.

As described in the paragraph “rounds” above, the composite material obtained after step b) or c), after performing a first round of the method for degrading the composite material according to the invention can be submitted again to the method for degrading a composite material according to the invention and thus replace the composite material CM in step a). A second round of the method according to the invention is then performed. Several rounds can be performed in this manner.

Then the method for recovering carbon fibers from a composite material CM comprises:
degrading the epoxy resin C comprised in the composite material CM by the method according to step a), and b) and optionally a′) and c), thereby obtaining a composite material CM3 or CM4, comprising carbon fibers and degradation products of the epoxy resin C,
said material CM3 or CM4 being either free of non-degraded epoxy resin C or comprising a remaining fraction of non-degraded epoxy resin C, and;
repeating degradation method of the composite material CM3 or CM4, by the method according to step a), and b) and optionally a′) and c), thereby obtaining a material CM3′ or composite material CM4′, comprising carbon fibers and degradation products of the epoxy resin C,
said material CM3′ or CM4′ being either free of non-degraded epoxy resin C or comprising a remaining fraction of non-degraded epoxy resin C, and;
separating the carbon fibers from the material CM3 or CM4.

Preferably, the composite material used in the second round for recovering the carbon fibers is the composite material CM4′.

Advantageously, the composite material CM comprises carbon fibers. Thus, in step b) or c), the composite material CM3′ or CM4′ with a reduced content in epoxy resin is obtained, and carbon fibers can be isolated.

### 5. Method of Recycling a Composite Material

The present invention deals with a method for recycling carbon fibers comprising the following steps:
recovering carbon fibers from a composite material CM by degrading the epoxy resin C comprised in the composite material CM and separating the carbon fibers from the material CM3 or CM4 by the method according to the invention; and
forming a composite material CM″, identical to or different from the composite material CM involved in the method according to the invention, said composite material CM″ comprising an epoxy resin C″, identical to or different from the epoxy resin C comprised in the composite material CM, and the recovered carbon fibers.

By “recycling” it should be understood any recovery operation by which waste materials are reprocessed into products, materials or substances whether for the original or other purposes. In other words, the recycled product does not need to be reused in the same original product, but also in other different products even used for different purposes.

A composite material is a material made from two or more constituent materials with significantly different physical or chemical properties that, when combined, produce a material with characteristics different from the individual components. Thus, typically, a composite material comprises a matrix and reinforcement.

In the present invention, the composite material comprises reinforcing fibers comprising carbon fibers and a matrix which comprises at least one epoxy resin.

The matrix comprises at least one epoxy resin C as described above. Thus, the matrix can comprise one or more epoxy resin as described above.

The matrix can also comprise other thermosetting resins, such as unsaturated polyesters, polyvinyl esters, phenolic resin and polyurethanes.

The matrix can also comprise another epoxy resin comprising units derived from at least one additional compound R3 as described above and at least one curing agent R2 as described above.

The matrix can also comprise thermoplastic resins such as polyetherimide (PEI), polyether sulfone (PES), polysulfone (PS), polyamideimide (PAI), polyamide (PA), polyester (PE), polyimide (PI), polyphenylene sulfide (PPS), polyetheretherketone (PEEK), polyetherketoneketone (PEKK), polyolefin or combinations thereof.

Advantageously, the matrix comprises polyamide particles, polyimide particles or combination thereof.

In particular, the matrix comprises polyetherimide, polyether sulfone or a combination thereof. These thermoplastic resins can be used as toughening agent. The matrix is then a thermoplastic toughened epoxy resin.

The matrix can also include accelerators enhancing or promoting the curing of the epoxy resin.

The matrix can comprise performance modifying agents such as core shell rubbers, flame retardants, wetting agents, pigments, dyes, UV absorbers, fillers, conducting particles and viscosity modifiers.

Preferably, the epoxy resin is the main constituent of the matrix. More preferably, it represents at least 50 wt. % of the matrix.

Advantageously, the carbon fibers can be recycled and used in a composite material CM″ identical or different from the composite material CM involved in the method of the invention.

Throughout the description, including the claims, all method terms should be understood as being synonymous with the term process.

The present invention will be illustrated by way of the following examples.

### EXAMPLES

Composite material of 1 cm×1 cm×0.334 cm containing 16 sheets of carbon fibres (70.52 wt %) embedded by an epoxy resin (29.48%) produced by the mixture and subsequent polymerization of diglycidylether bisphenol A (also noted as DGEBA) in the presence of 4,4′-Methylenebis(2,6-diethylaniline) (also noted as M-DEA), and has the following general structure:

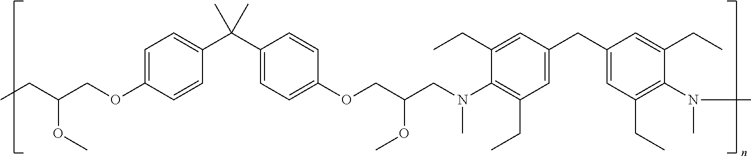

wherein n is an integer corresponding to the number of repeat units of the epoxy resin. The glass transition temperature, as measured by DSC using in accordance ASTM E 1356-08 (2014) on the composite, was 164° C.

In the examples, GST is added as a broth of lysed GST-expressing bacteria. It is produced following the process:
1. growing GST-expressing strain and centrifuging to obtain the cell pellets;
2. mixing cell pellets with phosphate buffer (0.1M pH=7.0) in a proportion of 1 g (of pellets)/10 ml (of buffer);
3. Lysing cells by sonication in the phosphate buffer to obtain a broth containing the GST.

In the examples, PHBH is added as a broth of lysed PHBH-expressing bacteria. It is produced following the process:
1. growing PHBH-expressing strain and centrifuging to obtain the cell pellets;
2. mixing cell pellets with phosphate buffer (0.1M pH=7.0) in a proportion of 1 g (of pellets)/10 ml (of buffer);
3. Lysing cells by sonication in the phosphate buffer to obtain a broth containing the PHBH.

In the examples, ET004 is added as a broth of lysed ET004-expressing bacteria. It is produced following the process:
1. growing ET004-expressing strain and centrifuging to obtain the cell pellets;
2. mixing cell pellets with phosphate buffer (0.1M pH=7.0) in a proportion of 1 g (of pellets)/10 ml (of buffer);
3. Lysing cells by sonication in the phosphate buffer to obtain a broth containing the ET004.

A serie of experiments (Tests 1 to 4), including controls (Test 1′ to 4′) were performed. In the tests, different methods were evaluated, using a combination of steps according to the present invention, which may or may not include all the four steps disclosed. Despite the suppression of a given step, as showed at Table 2, the order of them was never changed.

Control experiments, in which the presence of the enzymes was suppressed at step b), were performed to understand the significance of adding enzymes to the system (Test 1′ to 4′). Every process was then, performed with enzymes, and without these substances, in which the only difference between the two types of experiments is the presence, or not, of the enzymes during the step b).

TABLE 2
Tests 1 to 4 and the steps performed on the composite materials.

| Test | Step a) | Step a’) | Step b) | Step c) | Rounds |
|---|---|---|---|---|---|
| Test 1 | — | x | x | x | 2 |
| Test 2 | x | x | x | x | 2 |
| Test 3 | x | x | x | — | 2 |
| Test 4 | x | x | x | x | 2 |
| Test 1’ | — | x | x | x | 2 |
| Test 2’ | x | x | x | x | 2 |
| Test 3’ | x | x | x | — | 2 |
| Test 4’ | x | x | x | x | 2 |

In Table 2, (—) means step not performed and (x) means step performed. Then,
Test 1 and Test 1’: only steps a’), b) and c) were performed.
Test 2 and Test 2’: all steps a), a’), b) and c) were performed.
Test 3 and Test 3’: only steps a), a’) and b) were performed.
Test 4 and Test 4’: all ateps a), a’), b) and c) were performed.

### Example 1—Step a) Submitting a Composite Material to a Solvent

This step aims at swelling and potentially exfoliating the composite material into sheets of carbon fibers embedded by remaining resin matrix in order to enhance the surface area of the composite material and to allow better diffusion of the reagents used in the following steps.

Firstly, a mixture M1 containing 0.9300 g of n=2 units of 1 cm×1 cm×3.34 mm square of composite materials CM+50.00 g Benzyl alcohol (BZA) or Cyrene (CRN) was prepared. The mixture M1 was heated at 200° C. for 5 h without stirring following the filtration of M1 to separate the exfoliated composite material CM from the supernatant solution. The composite material CM was washed with 200 ml of 18.2 mΩ Millie-Q water and 200 ml of anhydrous ethanol, using arbitrary and alternate portions and the resulted composite material CM1 was dried in an oven, at 35° C., for 24-72 h, and reserved for further degradation.

### Result

The swelling ration S % and degree of exfoliation D.E. % were calculated using Equations 1 and 2, respectively.

$$S ( \% ) = \frac{{m}_{final} - {m}_{initial}}{{m}_{final}} \cdot 100 \qquad Eq . 1$$

$$D . E . ( \% ) = \frac{{n}_{composite sheets}}{X , {n}_{composite coupons}} \cdot 100 \qquad Eq . 2$$

In Equation 1, mᵢₙᵢₜᵢₐₗ and m_{final} are the inicial and final registered masses for composite material CM before and after the treatment, respectively.

In Equation 2, n_{composite sheets}, n_{composite coupons} and X are de number of observed sheets derived from the composite coupons, after the exfoliation treatment, number of composite coupons before the exfoliation treatment and the number of carbon-fiber sheets in each, respectively. For this study of case, X was always 16.

The results can be demonstrated in the Table 3 below:

| 1^{st} RND | |
|---|---|
| Invention Test | Control Test |

| Test | Solvent | S % | DE % | S % | DE % |
|---|---|---|---|---|---|
| Test 2 BZA | BZA | 9 | 56 | — | — |
| Test 2 CRN | CRN | 14 | 44 | — | — |
| Test 3 BZA | BZA | 10 | 53 | — | — |
| Test 3 CRN | CRN | 13 | 28 | — | — |
| Test 4 BZA | BZA | 9 | 62 | — | — |
| Test 2’ BZA | BZA | — | — | 11 | 63 |
| Test 2’ CRN | CRN | — | — | 17 | 38 |
| Test 3’ BZA | BZA | — | — | 12 | 66 |
| Test 3’ CRN | CRN | — | — | 15 | 34 |
| Test 4’ BZA | BZA | — | — | 9 | 56 |

It was observed, after the first round of degradation method for tests 1 to 4, that both solvents, benzyl alcohol and cyrene, could successfully swell and exfoliate the composite. Benzyl alcohol demonstrated better exfoliating properties, while cyrene demonstrated better swelling properties.

### Example 2—Step a′) Contacting the Composite Material CM with Anhydrous Sodium Phosphate Dibasic (Na₂HPO₄)

After performing step a) on the composite material CM, step a′) was performed on the composite material CM1 according to the method described below in order to allow the phosphorylation of the epoxy resin.

Firstly, a mixture M2 of 1.0177 g of the composite material CM1+5.40 g Na₂HPO₄+1.50 g β-Cyclodextrin+22.8 g of 18.2 mΩ Millie-Q H₂O was prepared. The mixture M2 was heated at 90° C. for 48 hours under stirring following the filtration of the mixture M2 under reduced pressure at hot condition, to separate the composite material CM from supernatant solution. The composite material CM was washed with 400 ml, in arbitrary portions, of 18.2 mΩ Millie-Q H₂O. The resulted composite material CM2 was dried at 35° C. for 24-72 h, and was reserved for further degradation.

### Example 3—Step b) Treating Enzymatically by Contacting Composite Material with a Glutathione S-Transferase

After performing step a) on composite material CM, step b) was performed on composite material CM2 according to the method described below in order to promote degradation of epoxy resin by enzymes:
Glutatione S-transferase issued from a N. aromaticivorans strain and named “NaLigE”.
   mutant para-hydroxybenzoate hydroxylase enzyme issued from Pseudomonas aeruginosa: M010-2 (L199V and Y385F mutant enzyme issued from Pseudomonas aeruginosa),

First, the stock and buffer solutions were prepared using the amount of reagents described in Table 4:

TABLE 4
Preparation of Stock and Buffer solutions:

| Solution type | Reagent | Mass amount (g) |
|---|---|---|
| Stock solution | 18.2 mΩ Millie-Q H₂O | 64 |
| | D-(+)-Glucose | 11.25 |
| | reduced Glutathione (GSH) | 0.22 |
| | Glicine | 1.07 |
| Buffer solution | Anhydrous Na₂HPO₄ | 13.9 |
| | 18.2 mΩ Millie-Q H₂O | 17 |
| | β-Cyclodexrin | 1.54 |

In a second preliminary step, a cofactors solution is prepared by mixing 2.0 wt % of NADP (beta-nicotinamide adenine dinucleotide phosphate) and 0.4 wt % of FAD (flavin adenine dinucleotide) at a 0.1 M aqueous phosphate buffer solution at pH=7.00.

The enzymatic treating was performed according to the method described as follows:

Firstly, a mixture of 0.9458 g of composite material CM2+76.50 g stock solution+0.55 g cofactors solution+30.00 g buffer solution+3.00 g enzyme Glutathione-S-Transferase (GST)+1.80 g enzyme Glucose dehydrogenase (ET004)+3.00 g enzyme para-hydroxybenzoate hydroxylase (PHBH) was prepared obtaining the mixture M3. The pH of mixture M3 was corrected to approximately 9 using a 2 M aqueous solution of NaOH and the mixture M3 was heated at 30° C. for 72 hours under 400 rpm using mechanical stirring and the reaction medium was supplied with O₂(g) during the whole reaction time. The mixture M3 was then filtered to separate composite material CM3 from supernatant solution. The composite material CM3 was washed using 400 ml of 18.2 mΩ Millie-Q water, dried at 35° C. for 24-72 hours, and reserved for further degradation.

Tests 2 and 3: The system used during tests 2 and 3 include a round bottom flask connected to a condenser and using magnetic stirring. The whole system was heated in a silicon oil bath. Reaction medium was not supplied with O₂(g), pH control was not performed for the whole process of the tests 2 and 3.

Test 4—The system used a glass jacketed reactor connected to a water bath promoting a better temperature control, with a mechanical stirrer, connected to a Rushton impeller. The system was connected to a O₂(g) line and the pH of the reaction was corrected to approximately 9 using NaOH 3M aqueous solution during the whole process, as needed.

### Result

Supernatant solution was analyzed by LCMS technique in the following conditions in order to identify byproducts from the degradation of the matrix.
LCMS conditions
HPLC characterization conditions:
(1) the mobile phase
Solution A: Water (2 mM NH₄Ac)
Solution B: Acetonitrile
A: B ratio=gradient from 95:5 to 5:95
(2) Flow rate: 0.4 mL/min
(3) column: Waters BEH C18 50 mm×2.1 mm, 1.7 μm
(4) MS ionization mode: ESI+ and ESI−
(5) Scan mode: MS full scan, m/z 50-1500
(6) Spray voltage: ESI+=3.0 kV and ESI−=2.5 kV
(7) Cone voltage: 40 V
(8) Source temperature: 150° C.
(9) Desolvation temperature: 450° C.
(10) Cone gas: 50 L/h
(11) Desolvation Gas Flow: 900 L/h

It was demonstrated by LCMS that structures of fragments with mass MS+H of 817.4998; 815.4858; 377.1959; 315.1813; 197.1325; 214.1590 were produced by enzymatic action under epoxy resin C degradation.

The mass loss of the composite material obtained for each test was calculated after all the tests were performed.

### Example 4—Step c) Contacting Composite Material CM4 with Sodium Hydroxide (NAOH)

After performing step b) on the composite material CM, step c) was performed on composite material CM3 according to the method described below.

Firstly, a mixture M4 of 0.8744 g of composite material CM3+50.00 g of 2 M aqueous solution of NaOH was prepared. Then, the mixture M4 was heated at 90° C. for 48 hours using stirring. The mixture M4 was filtered under vacuum to separate composite material CM, from supernatant solution. The composite material CM3 was washed with 400 ml 18.2 mΩ water and dried at 35° C. for 24-72 hours. The obtained composite material CM4 was weighted for calculation of mass loss and reserved for further degradation.

The dried composite material CM4 was weighted to calculate the final mass loss of the composite after the first round of tests of the invention.

### Example 5—Two Rounds of the Method According to the Invention

### 1^{st} Round

### Step a)

Firstly, a mixture M1 containing 0.9300 g of n=2 units of 1 cm×1 cm×3.34 mm square of composite materials CM+50.00 g Benzyl alcohol (BZA) or Cyrene (CRN) was prepared. The mixture M1 was heated at 200° C. for 5 h without stirring following the filtration of M1 to separate the exfoliated composite material CM from the supernatant solution. The composite material CM was washed with 200 ml of 18.2 mΩ Millie-Q water and 200 ml of anhydrous ethanol, using arbitrary and alternate portions and the resulted composite material CM1 was drying in an oven, at 35° C., for 24-72 h, and reserved for further degradation.

Step a′)

Firstly, a mixture M2 of 1.0177 g of the composite material CM1+5.40 g Na₂HPO₄+1.50 g β-Cyclodextrin+22.8 g of 18.2 mΩ Millie-Q H₂O was prepared. The mixture M2 was heated at 90° C. for 48 hours under stirring following the filtration of the mixture M2 under reduced pressure at hot condition, to separate the composite material CM, from supernatant solution. The composite material CM was washed with 400 ml, in arbitrary portions, of 18.2 mΩ Millie-Q H₂O. The resulted composite material CM2 was dried at 35° C. for 24-72 h, and was reserved for further degradation.

### Step b)

Firstly, a mixture of 0.9458 g of composite material CM2+76.50 g stock solution+0.55 g cofactors solution+30.00 g buffer solution+3.00 g enzyme Glutathione-S-Transferase (GST)+1.80 g enzyme Glucose dehydrogenase (ET004)+3.00 g enzyme para-hydroxybenzoate hydroxylase (PHBH) was prepared obtaining the mixture M3. The pH of mixture M3 was corrected to approximately 9 using a 2 M aqueous solution of NaOH and the mixture M3 was heated at 30° C. for 72 hours under 400 rpm using mechanical stirring and the reaction medium was supplied with O₂(g) during the whole reaction time. The mixture M3 was then filtered to separate composite material CM3 from supernatant solution. The composite material CM3 was washed using 400 ml of 18.2 mΩ Millie-Q water, dried at 35° C. for 24-72 hours, and reserved for further degradation.

Tests 2 and 3: The system used during tests 2 and 3 include a round bottom flask connected to a condenser and using magnetic stirring. The whole system were heated in a silicon oil bath.

Reaction medium was not supplied with O₂(g), pH control was not performed for the whole process of the tests 2 and 3.

Test 4—The system used a glass jacketed reactor connected to a water bath promoting a better temperature control, with a mechanical stirrer, connected to a Rushton impeller made out of steel. The system was connected to a O₂ line and the pH of the reaction was corrected to approximately 9 using NaOH 3M aqueous solution during the whole process, as needed.

### Steps c)

Firstly, a mixture M4 of 0.8744 g of composite material CM3+50.00 g of 2 M aqueous solution of NaOH was prepared. Then, the mixture M4 was heated at 90° C. for 48 hours using stirring. The mixture M4 was filtered under vaccum to separate composite material CM, from supernatant solution. The composite material CM3 was washed with 400 ml 18.2 mΩ water and dried at 35° C. for 24-72 hours. The obtained composite material CM4 was weighted for calculation of mass loss and reserved for further degradation.

### 2^{nd} Round

The solid from 1^{st} Round is submitted again to the whole steps, without changing the order or the parameters of each test performed.

### Step a)

Firstly, a mixture M1 containing 0.8700 g of composite materials CM4+50.00 g Benzyl alcohol (BZA) or Cyrene (CRN) was prepared. The mixture M1′ was heated at 200° C. for 5 h without stirring following the filtration of M1′ to separate the exfoliated composite material CM from the supernatant solution. The composite material CM was washed with 200 ml of 18.2 mΩ Millie-Q water and 200 ml of anhydrous ethanol, using arbitrary and alternate portions and the resulted composite material CM1′ was drying in an oven, at 35° C., for 24-72 h, and reserved for further degradation.

Step a′)

Firstly, a mixture M2′ of 0.9234 g of the composite material CM1′+5.40 g Na₂HPO₄+1.50 g β-Cyclodextrin+22.8 g of 18.2 mΩ Millie-Q H₂O was prepared. The mixture M2′ was heated at 90° C. for 48 hours under stirring following the filtration of the mixture M2′ under reduced pressure at hot condition, to separate the composite material CM, from supernatant solution. The composite material CM was washed with 400 ml, in arbitrary portions, of 18.2 mΩ Millie-Q H₂O. The resulted composite material CM2′ was dried at 35° C. for 24-72 h, and was reserved for further degradation.

### Step b)

Firstly, a mixture of 0.8532 g of composite material CM2′+76.50 g stock solution+0.55 g cofactors solution+30.00 g buffer solution+3.00 g enzyme Glutathione-S-Transferase (GST)+1.80 g enzyme Glucose dehydrogenase (ET004)+3.00 g enzyme para-hydroxybenzoate hydroxylase (PHBH) was prepared obtaining the mixture M3′. The pH of mixture M3′ was corrected to approximately 9 using a 2 M aqueous solution of NaOH and the mixture M3′ was heated at 30° C. for 72 hours under 400 rpm using mechanical stirring and the reaction medium was supplied with O₂(g) during the whole reaction time. The mixture M3′ was then filtered to separate composite material CM3′ from supernatant solution. The composite material CM3′ was washed using 400 ml of 18.2 mΩ Millie-Q water, dried at 35° C. for 24-72 hours, and reserved for further degradation.

Tests 2 and 3: The system used during tests 2 and 3 include a round bottom flask connected to a condenser and using magnetic stirring. The whole system were heated in a silicon oil bath. Reaction medium was not supplied with O₂(g), pH control was not performed for the whole process of the tests 2 and 3.

Test 4—The system used a glass jacketed reactor connected to a water bath promoting a better temperature control, with a mechanical stirrer, connected to a Rushton impeller made out of steel. The system was connected to a O₂ line and the pH of the reaction was corrected to approximately 9 using NaOH 3M aqueous solution during the whole process, as needed.

### Steps c)

Firstly, a mixture M4′ of 0.8145 g of composite material CM3′+50.00 g of 2 M aqueous solution of NaOH was prepared. Then, the mixture M4′ was heated at 90° C. for 48 hours using stirring. The mixture M4′ was filtered under vaccum to separate composite material CM, from supernatant solution. The composite material CM3′ was washed with 400 ml 18.2 mΩ water and dried at 35° C. for 24-72 hours. The obtained composite material CM4′ was weighted for calculation of mass loss and reserved for further degradation.

### Conclusion

The mass loss for all tested performed, including the tests according to the invention and the control tests is described by Table 5 below:

TABLE 5

| | | 1^{st} Round | | 2^{nd} Round | |
|---|---|---|---|---|---|
| | Solvent | Invention | Control | Invention | Control |
| Test 1 | — | 2.1 | — | 2.8 | — |
| Test 2 BZA | BZA | 3.5 | — | 8.7 | — |
| Test 2 CRN | CRN | 0.4 | — | 6.2 | — |
| Test 3 BZA | BZA | 1.5 | — | 5.3 | — |
| Test 3 CRN | CRN | −2.7 | — | −1.9 | — |
| Test 4 BZA | BZA | 6.5 | — | 16.5 | — |
| Test 1’ | — | — | 0.8 | — | 1.5 |
| Test 2’ BZA | BZA | — | 1.7 | — | 9.4 |
| Test 2’ CRN | CRN | — | −1.1 | — | 4.4 |
| Test 3’ BZA | BZA | — | −1.6 | — | 5.0 |
| Test 3’ CRN | CRN | — | −4.8 | — | 0.6 |
| Test 4’ BZA | BZA | — | 3.9 | — | 10.6 |

As can be seen in Table 5, the mass loss of the composite material is enhanced when submitted to a first solvent treatment with a solvent having better exfoliating properties than sweeling properties. Benzyl alcohol (BZA) demonstrated better exfoliation properties compared to cyrene (CRN) and, then better mass loss at the end of all tests (Test 2, 3 and 4 with BZA).

All invention tests (Tests 1, 2, 3 and 4) exhibit an increased mass loss compared to control tests (Tests 1′, 2′, 3′ and 4′) demonstrating the importance and efficiency of enzymes degradation for mass loss of the composite material.

When the pretreatment step a) is suppressed (Test 1 and Test 1′), the mass loss of the composite material is lower and comparable after the 1^{st} and 2^{nd} rounds, showing limited activity of enzymes on degradation of the composite material, potentially due to the low surface area and highly compact structure.

Test 2 demonstrate an increasing in mass loss, compared to the control and also with an additional round, particularly better for Benzyl alcohol (Test 2 BZA) showing the importance of the swelling and exfoliation for promoting an enhanced enzyme activity. This clearly confirms that the higher surface area, directly proportional to the degree of exfoliation, facilitates the action of the enzymes, by eliminating or reducing the compactness nature of the original composite material and exposing more resin to the reaction medium.

Test 3 demonstrate that the suppression of step c) when the composite material is submitted to a chemical post-treatment with NaOH can affect the mass loss of the composite material, proving that this additional step can increase the degradation of the composite material by cleavage of epoxy resin. Again, the result is clearly better when benzyl alcohol (Test 3 BZA) is used and the exfoliation is better, so the enzyme activity is also enhanced when compared to cyrene (Test 3 CRN), since BZA showed better exfoliating properties than CRN.

Test 4 clearly confirms the higher mass loss is not only affected by the swelling and, particularly exfoliating capacity of the solvent but also by the controlling of enzymatic reaction medium step to guarantee the optimal performance of enzymes.

Therefore, surprisingly, it has been found a method for degrading composite material using mild conditions having a chemical pretreatment with a solvent able to promote the swelling and exfoliation of the composite, increasing its surface area and consequently the enzyme diffusion and its activity in the composite, promoting the degradation of the resin, allowing the recovery of carbon fibers, which can be recycled.

It should be understood that the invention is not limited by the above description but rather by the claims appended hereto.

1. A method for degrading a composite material comprising the following successive steps:
a) submitting a composite material CM comprising an epoxy resin C and reinforcing fibers to a chemical pretreatment, said chemical pretreatment comprising contacting the composite material CM with an organic solvent having a boiling point greater than the glass transition temperature Tg of the composite material CM at a treatment temperature Tₜᵣ of at least 100° C. and exceeding by at least 10° C. the glass transition temperature Tg of the composite material CM to obtain composite material CM1, wherein:
the treatment temperature Tₜᵣ exceeds by at least 10° C. the glass transition temperature T_{g} of the composite material CM as determined by DSC in accordance ASTM E1356-08 (2014), with the proviso that when no glass transition temperature can be detected by DSC in accordance ASTM E1356-08 (2014), the treatment temperature Tₜᵣ satisfies at least one condition chosen from conditions (c1) and (c2);
wherein condition (c1) is that a glass transition temperature T_{g2} can be determined by DMA in accordance with ASTM D7028-07 (2015) and the treatment temperature Tₜᵣ exceeds by at least 10° C. the glass transition temperature T_{g2}; and
wherein condition (c2) is that the treatment temperature is of at least 300° C.; then,
b) submitting the composite material obtained after step a) to an enzymatic treatment, said enzymatic treatment comprising contacting the composite material with at least one enzyme to obtain composite material CM3;
wherein steps a) and b) are performed at least once.

2. The method according to claim 1, wherein the glass transition temperature Tg is detected by DSC in accordance ASTM E1356-08(2014).

3. The method according to claim 1, wherein the epoxy resin C comprises units derived from at least one aromatic compound R1 bearing at least two epoxide groups per molecule and comprising at least one aromatic ring bearing at least one glycidyloxy group, and at least one curing agent R2.

4. The method according to claims 1, wherein the reinforcing fibers are carbon fibers.

5. The method according to claim 1, wherein the chemical pretreatment of step a) further comprises step a′) comprising contacting the composite material CM1 with an aqueous solution of phosphoric acid and/or a salt thereof after the composite material CM1 has been contacted with the organic solvent to obtain composite material CM2.

6. The method according to claim 1, wherein the enzyme is a glutathione S-transferase.

7. The method according to claim 6, wherein the enzymatic treatment further comprises contacting the composite material CM1 or CM2 with a para-hydroxybenzoate hydroxylase.

8. The method according to claim 7, wherein either the composite material CM1 or CM2 is concomitantly contacted with the glutathione S-transferase and the para-hydroxybenzoate hydroxylase, or the composite material CM1 or CM2 is firstly contacted with the glutathione S-transferase and is thereafter contacted with the para-hydroxybenzoate hydroxylase.

9. The method according to claim 1, which further comprises step c); submitting the composite material CM3 to a chemical post-treatment, said chemical post-treatment comprising contacting the composite material CM3 with an aqueous solution comprising a strong Bronsted base to obtain composite material CM4.

10. A method for recovering carbon fibers from a composite material CM, said method comprising:
degrading the epoxy resin C comprised in the composite material CM by the method according to claim 1, thereby obtaining a composite material CM3 or CM4, comprising carbon fibers and degradation products of the epoxy resin C, said material CM3 or CM4 being either free of non-degraded epoxy resin C or comprising a remaining fraction of non-degraded epoxy resin C; and
separating the carbon fibers from the material CM3 or CM4.

11. A method for recycling carbon fibers, said method comprising:
recovering carbon fibers from a composite material CM by a method comprising:
degrading the epoxy resin C comprised in the composite material CM by the method according to claim 1, thereby obtaining a composite material CM3 or CM4, comprising carbon fibers and degradation products of the epoxy resin C, said material CM3 or CM4 being either free of non-degraded epoxy resin C or comprising a remaining fraction of non-degraded epoxy resin C; and
separating the carbon fibers from the material CM3 or CM4; and
forming a composite material CM″, identical to or different from the composite material CM involved in the method according to claim 1, said composite material CM″ comprising an epoxy resin C″ identical to or different from the epoxy resin C comprised in the composite material CM, and the recovered carbon fibers.
